(19) United States
(12) Patent Application Publication
(10) Pub. No.: US 2010/0255193 A1
(43) Pub. Date: Oct. 7, 2010

(54) LENS MANUFACTURING METHOD AND COATING LIQUID MANUFACTURING METHOD

(75) Inventors: Takeshi Imizu, Tokyo (JP); Takamitsu Hirose, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: HOYA CORPORATION, Shinjuku-ku (JP)

(21) Appl. No.: 12/730,755

(22) Filed: Mar. 24, 2010

(30) Foreign Application Priority Data
Mar. 31, 2009 (JP) 2009-088046

(51) Int. Cl. B05D 5/06; B29D 11/00; B01D 35/02; B01D 39/00

(52) U.S. Cl. 427/164; 210/767

(57) ABSTRACT

A coating liquid manufacturing step for manufacturing a coating liquid for being coated on a lens substrate includes a step for filtering an original coating liquid with a filter having a fiber structure, the original coating liquid being prepared by mixing coating materials. The filter has an organic fiber layer (2) and an inorganic fiber layer (1). The original coating liquid is filtered with the organic fiber layer side as primary side.

### CROSS REFERENCES TO RELATED APPLICATIONS

The present invention contains subject matter related to Japanese Patent Application JP 2009-088046 filed in the Japanese Patent Office on Mar. 31, 2009, the entire contents of which being incorporated herein by reference.

### BACKGROUND OF THE INVENTION

1. Field of the Invention

The present invention relates to a manufacturing method of a lens for spectacles or the like including a coating liquid preparing step, and a coating liquid manufacturing method.

2. Description of the Related Art

Lenses, particularly plastic lenses, of optical products such as spectacles generally have various coats formed on the surface(s) thereof. Methods for forming the coats include dry film-forming methods and wet film forming methods. Examples of the dry film-forming methods include an evaporation method and the like, and examples of the wet film forming methods include a spin-coating method, a dip-coating method and the like.

Among these methods, in the case where the wet film forming method is used to form a film, a filtration process generally needs to be performed in order to filter out foreign matters and the like contained in a coating liquid. If the coat is formed using a coating liquid with the foreign matters contained therein, the foreign matters will appear in the formed film, therefore affecting the quality of the optical product.

Examples of the coating liquid, which is the material of each of the various coats, include a coating liquid for forming a hard coat layer, and a coating liquid for forming a primer layer adapted to improve adhesion between layer and layer or between substrate and layer, and/or to improve impact resistance of the lens itself, wherein the coating liquid for forming the hard coat layer has an oxide sol dispersed therein.

Examples of the primer layer include a polyurethane layer adapted to improve adhesion and impact resistance (see, for example, Japanese Unexamined Patent Application Publication No. 2008-007665 (referred to as “Patent Document 1” hereinafter), Japanese Unexamined Patent Application Publication No. 2005-199683 (referred to as “Patent Document 2” hereinafter), and Japanese Unexamined Patent Application Publication No. 2007-23174 (referred to as “Patent Document 3” hereinafter)).

A coating liquid containing isocyanate and polyol, or an emulsion-like coating liquid containing fully reacted polyurethane may be used to form the polyurethane layer, which is a preferable primer layer disclosed in the aforesaid Patent Documents 1 to 3. Gel-like aggregates are prone to be generated in the both coating liquids. Deposition of the gel-like aggregates is a serious problem particularly in the case where the polyurethane-containing emulsion-like coating liquid is used.

To reliably filter out various foreign matters including the gel-like aggregates, it is necessary to select suitable filtration accuracy. If filtration accuracy is low, there will be a concern that the foreign matters can not be reliably filtered out. Further, if gel is left in a coating liquid where the gel is prone to be deposited, for example, the gel will grow with time. Thus, in order to reduce injection rate of products, the filtration accuracy needs to be increased. On the other hand, if simply increasing filtration accuracy, the filter will be prone to clogging which leads to low yield, and therefore there will be a concern that productivity will be reduced and cost will be increased.

### SUMMARY OF THE INVENTION

An object of the present invention is to, when filtering an original coating liquid (as a coating material) containing foreign matters such as gel and/or the like, filter out the foreign matters in a favorable manner and restrain yield loss of a final coating liquid.

To solve the aforesaid problems, a lens manufacturing method according to an aspect of the present invention includes: a substrate forming step for forming a lens substrate, a coating liquid manufacturing step for manufacturing a coating liquid for being coated on the lens substrate, and a step for coating the coating liquid on the lens substrate. The coating liquid manufacturing step includes a filtration step for filtering an original coating liquid with a filter having a fiber structure. Further, the filter is a fiber filter with a multilayered structure which includes an organic fiber layer formed of organic fiber and an inorganic fiber layer formed of inorganic fiber, and the original coating liquid is filtered with the organic fiber layer side as a primary side.

In the specification and claims of the present invention, the term of “primary side” means an upstream in the moving direction of the filtrate of the filter, and the term of “secondary side” means a downstream in the moving direction of the filtrate of the filter. In other words, the filtrate penetrates from the filter from the primary side toward the secondary side.

Further, a coating liquid manufacturing method according to another aspect of the present invention includes the coating liquid manufacturing step.

Further, according to the present invention, the fiber filter with a multilayered structure which includes an organic fiber layer formed of organic fiber and an inorganic fiber layer formed of inorganic fiber is used as the filter for performing the filtration step. Further, in the filtration step, by filtering the original coating liquid with the organic fiber layer side as the primary side, the foreign matters such as gel can be reliably captured and filtered out from the filtrate.

When capturing deformable foreign matters such as gel component and/or the like as residue, if a filter formed of soft fiber such as organic fiber is used, the gel and/or the like contained in the original coating liquid will be deformed together with the fiber, and therefore the gel and/or the like will pass through the filter, so that the foreign matters can not be captured. Such phenomenon occurs when a filter formed of soft polymer organic fiber only is used, and therefore function of the filter can not be achieved. On the other hand, if a hard inorganic fiber is used, deformation of the fiber of the filter can be restrained. As a result, gel capture rate of the filter is improved, and penetration of the gel through the filter is reduced.

In other words, by providing an inorganic fiber layer and an organic fiber layer so that the inorganic fiber layer and the organic fiber layer are adjacent to each other, shape stability of the organic fiber can be improved due to being supported by the inorganic fiber. As for the shape of the filter, the filter may also be bent into a folded shape in order to increase the filtration area. Even if the filter is bent into such a shape, since the shape stability of the organic fiber layer is improved by the inorganic fiber layer, the filtering capacity does not decrease in the whole process of the filtration step, from beginning to end.

It is preferred that, in the lens manufacturing method according to the present invention, the filtration step includes a secondary filtration step for filtering a filtrate obtained by performing filtration (primary filtration) with the aforesaid fiber filter having multilayered structure with a secondary filter. The type of the secondary filter is not particularly limited, however it is preferred that a filter having higher capability of capturing tiny gel than the primary filter is used as the secondary filter. By further performing filtration with the secondary filter, the gel can be more reliably removed.

Incidentally, in the description of the present invention, the liquid obtained by mixing coating liquid materials before the filtration step is referred to as the “original coating liquid”, the filtrate obtained after the primary filtration step is referred to as a “primary filtrate”, and the filtrate obtained after the secondary filtration step is referred to as a “secondary filtrate”.

In the case where the secondary filtration is performed, when filtering the original coating liquid for lens, most foreign matters are filtered out in the primary filtration step, and relatively tiny foreign matters are removed in the secondary filtration step. By performing the two-stepped filtration in such a manner, it is possible to efficiently filter out the foreign matters including the gel-like aggregates and/or the like in the primary filtration step.

According to the present invention, even if the original coating liquid contains gel component, the gel component can be reliably filtered out in the primary filtration step. Since the gel can be substantially removed in the primary filtration step, if the primary filtrate is reserved, the gel will be less prone to grow. Further, by performing the secondary filtration step, the tiny gel failed to be captured by the primary filter can be filtered out by the secondary filter, and further, the tiny gel newly generated in the primary filtrate can be removed.

It is preferred that, in the lens manufacturing method according to the present invention, a membrane filter is used as the secondary filter. The membrane filter means a filter having a base body formed with many pores, wherein the pores having relatively even size. By employing such filter as the secondary filter, a filtration with sufficient accuracy can be performed to obtain the final coating liquid for lens (as an optical product).

Further, it is preferred that the organic fiber layer is provided on both the primary side and the secondary side of the filter with the inorganic fiber layer interposed therebetween. By providing the organic fiber layer on both sides of the inorganic fiber layer, the foreign matters such as the gel and/or the like can be reliably filtered out. Further, each of the both surfaces of the fiber filter can be used as the primary side.

Furthermore, it is preferred that the organic fiber layer is obtained by laminating a plurality of organic fiber layers to each other, each of the organic fiber layers having different filtration accuracy. By providing the plurality of organic fiber layers each having different filtration accuracy, the gel of different size can be captured in different areas inside the organic fiber layer. Thus, clogging of the primary filter as a whole can be restrained.

Incidentally, the filtration accuracy in the description of the present invention is an index represented by “diameter of captured particles” and “capture efficiency” (measured by percentage). The smaller the diameter of captured particles is (or the higher the capture efficiency is), the higher the filtration accuracy is. Incidentally, the capture efficiency can be obtained by filtering dispersed water prepared by dispersing test powders into water at a predetermined flow rate, and measuring weight of the powders filtered out from the dispersed water, wherein the test powders meet Japanese Industrial Standard (JIS) JIS Z 8901 (Test powders and test particles).

In the present invention, it is preferred that glass fiber is used as the inorganic fiber of the primary filter. Since diameter of the glass fiber can be made tiny, the gel can be reliably captured with high void ratio. Further, by increasing the void ratio of the fiber, the filtration rate can be maintained without inhibiting the flow of the filtrate. Further, since the glass fiber has sufficient hardness, the organic fiber can be strongly supported in the area contacting the glass fiber.

Further, it is preferred that polyolefin fiber such as polypropylene fiber is used as the organic fiber of the primary filter. Polyolefin has no polar side chain, and polyolefin fiber has fixed shape. Therefore, filtration can be performed in a stable manner regardless of the liquidity of the coating liquid.

In the case where the original coating liquid is an emulsified liquid, due to variation of dispersion state of two media and bias of electric charges, tiny gel-like substance is prone to be generated. If tiny gel is generated, the gel will be grown with the tiny gel as core. According to the present invention, by using the primary filter with a multilayered structure including the organic fiber layer and the inorganic fiber layer to reliably capture the tiny gel previously, growing of the gel in the primary filtrate can be restrained.

According to the present invention, even if the original coating liquid is water-dispersible polyurethane, by favorably performing a primary filtration, yield of the secondary filtration can be prevented from lowering. Further, by using a primary filter with high accuracy, the secondary filtration step can be omitted.

Further, in the case where the coating liquid is a primer liquid for spectacle lens, by favorably performing the primary filtration and the secondary filtration, yield of the primer liquid can be prevented from lowering, and further, injection rate of the spectacle lens caused by the foreign matters resided in the primer layer can be reduced.

According to the present invention, when filtering an original coating liquid containing foreign matters such as gel and/or the like, by performing filtration using the fiber filter having the organic fiber layer and the inorganic fiber layer with the organic fiber layer side as the primary side, the foreign matters can be favorably filtered out. According to the present invention, yield of the filtrate (i.e., the coating liquid) of the secondary filtration step can be prevented from lowering.

### BRIEF DESCRIPTION OF THE DRAWINGS

FIG. 1 is a flowchart showing a manufacturing process of a lens manufacturing method according to an embodiment of the present invention;

FIG. 2 is a cross section schematically showing the configuration of an example of a primary filter used in the filtration step according to the aforesaid embodiment of the present invention;

FIG. 3 is a cross section schematically showing the configuration of another example of the primary filter used in the filtration step according to the aforesaid embodiment of the present invention;

FIG. 4A is a cross section schematically showing the configuration of further another example of the primary filter used in the filtration step according to the aforesaid embodiment of the present invention;

FIG. 4B schematically shows an enlarged cross section of an organic fiber layer of the primary filter shown in FIG. 4A;

FIG. 5A is a cross section schematically showing the configuration of an example of a secondary filter used in the filtration step according to the aforesaid embodiment of the present invention;

FIG. 5B is a cross section schematically showing the configuration of the secondary filter shown FIG. 5A, the cross section being taken along line A-A of FIG. 5A; and

FIG. 5C is a cross section schematically showing the configuration of another example of the secondary filter.

### DETAILED DESCRIPTION OF THE PREFERRED EMBODIMENT(S)

An embodiment of a lens manufacturing method and an embodiment of a coating liquid manufacturing method according to the present invention will be described below. Note that the present invention is not limited to these embodiments. Description will be made in the following order.

1. Embodiment of Lens Manufacturing Method (Outline of Lens Manufacturing Process)

2. Embodiment of Coating Liquid Manufacturing Method (Structure of Filter)
(1) Primary Filter
(2) Secondary Filter

3. Examples

### 1. Embodiment of Lens Manufacturing Method (Outline of Lens Manufacturing Process)

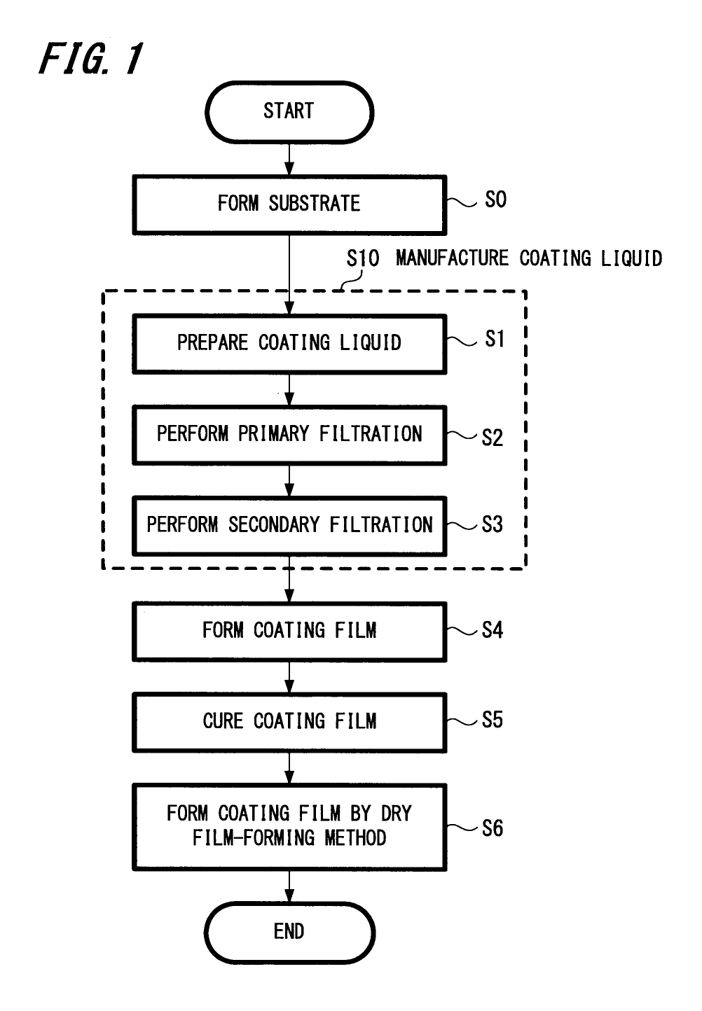

FIG. 1 is a flowchart showing a manufacturing process of the lens manufacturing method according to an embodiment of the present invention.

As shown in FIG. 1, a substrate forming step (Step S0) is first performed in which a substrate is prepared and then optical surface(s) thereof is formed, wherein the substrate is made of a plastic for lens. Both the material of the lens substrate and the method for manufacturing the lens substrate are not particularly limited, but may be suitably selected according to, for example, prescription of an order in the case of spectacle lens.

Examples of the material of the lens substrate include copolymer of methyl methacrylate and at least one other monomer, copolymer of diethylene glycol bisallyl carbonate and at least one other monomer, copolymer of polyurethane and polyurea, polycarbonate, polystyrene, polyvinyl chloride, unsaturated polyester, polyethylene terephthalate, polyurethane, polythiourethane, sulfide resin obtained by utilizing an ene-thiol reaction, sulfur-containing vinyl polymer and the like. Various additives may be added to these materials according to necessity. Further, the present invention may also be applied to the case where the coat is formed on a glass lens, instead of a plastic lens.

Further, the optical surface(s) of the lens may be formed by cast molding, injection molding or the like according to the difference of the aforesaid materials, or be formed by an NC (Numerical Control) cutting device such as a curve generator. Incidentally, the configuration may either be the one in which both optical surfaces of the substrate are formed in the substrate forming step, or be the one in which only one optical surface is formed and a coating film is formed thereon, and thereafter the other optical surface is formed.

After or while performing the substrate forming step S0, a coating liquid preparing step (Step S1) is performed in which the coating materials are mixed to prepare an original coating liquid. Type and material of the coating liquid are not particularly limited as long as the coating liquid is used to form a coating film on the surface of the optical member. It is preferred that the coating liquid is a liquid where gel-like aggregates generate with time, and it is particularly preferred that the coating liquid is a polymer emulsion. For example, the present invention can be applied to the water-based polyurethane mentioned in Patent Documents 1 to 3, which is material used to form a primer layer of a functional film such as a photochromic film, a hard coat or the like, wherein the media of the water-based polyurethane are water and polyurethane. Further, the present invention can be applied to various coating materials such as a coating material for forming the photochromic film itself, a coating material for forming a hard coat, a coating material for forming a water-repellent coat and the like, as long as the materials contain foreign matters such as gel and/or the like.

Next, a filtration step for filtering the original coating liquid is performed. In the filtration step, a primary filtration step (Step S2) is first performed in which a primary filtration is conducted with a primary filter (Step S2). Thereafter, a secondary filtration step (Step 3) is performed in which a secondary filtration is conducted with a secondary filter. Details about the structure of the primary filter and the structure of the secondary filter will be described later. By performing the aforesaid coating liquid preparing step S1, primary filtration step S2 and secondary filtration step S3, a coating liquid manufacturing step (Step S10) is completed, and thereby manufacture of a final coating liquid is completed.

Incidentally, in the case where the primary filter has high accuracy (for example, in the case where a filter having a diameter of captured particles of 1 μm or less and a capture efficiency of 98% or higher is used), the secondary filtration step (Step S3) can be omitted. In such a case, the filtration step can be simplified.

Next, a coating film forming step (Step S4) is performed in which the secondary filtrate after the secondary filtration is used as the final coating liquid to form a film on the substrate. A wet film forming method such as a dip-coating method, a spin-coating method, a spraying method or the like can be used to form the film. Thereafter, a curing step (Step S5) is performed in which a curing process by drying, heating and/or the like is conducted, and thereby the film formation is completed.

The aforesaid coating liquid manufacturing step S10, coating film forming step S4 and curing step S5 may also be performed two or more times according to type of coat and intended use. Further, a step for forming a coating film (such as an antireflection film and the like) by a dry film-forming method (Step S6) may be performed in addition to the aforesaid steps, according to necessity. Number of times of both the wet film forming process and the dry film-forming process and order of performing the both processes are not limited to those shown in FIG. 1. For example, a wet film forming process may be additionally performed after completion of the dry film-forming process.

By the aforesaid steps, the manufacturing process of the lens is completed.

### 2. Embodiment of Coating Liquid Manufacturing Method (Structure of Filters)

Next, the structure of the filtration filters used in the primary filtration step and the secondary filtration step of the coating liquid manufacturing step will be described below.

### (1) Primary Filter

### (1-a) First Example of Primary Filter

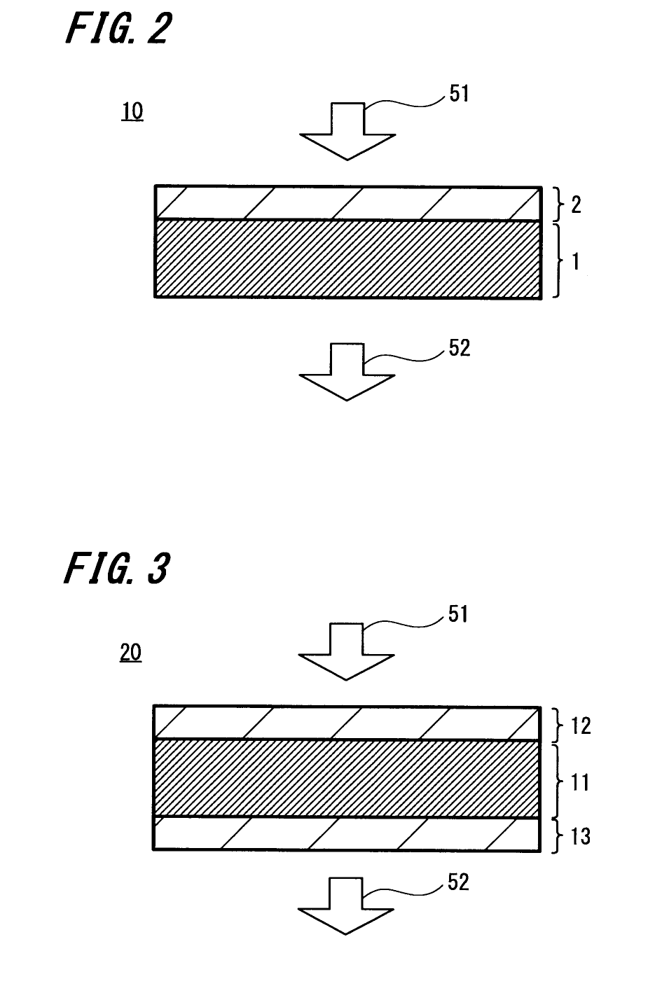

FIG. 2 is a cross section schematically showing the configuration of a first example of the primary filter. A primary filter 10 is configured as a fiber filter obtained by laminating an inorganic fiber layer 1 formed by inorganic fiber and an organic fiber layer 2 formed by organic fiber to each other so that the inorganic fiber layer 1 and the organic fiber layer 2 are adjacent to each other. In the example shown in FIG. 2, the inorganic fiber layer 1 serves as a support, and the organic fiber layer 2 is provided on the upper surface (the primary side) of the inorganic fiber layer 1. Filtration is performed with the organic fiber layer 2 side as the primary side. In other words, the original coating liquid is poured from the side of the organic fiber layer 2 as shown by an arrow 51, and the primary filtrate is obtained from the side of the inorganic fiber layer 1 as shown by an arrow 52. In such a case, since the shape of the organic fiber layer 2 is stabilized by the inorganic fiber layer 1, even if there are aggregates such as gel in the original coating liquid, the aggregates can be prevented from penetrating through the filter, and therefore the foreign matters can be reliably captured.

### (1-a) Second Example of Primary Filter

FIG. 3 is a cross section schematically showing the configuration of a second example of the primary filter. In the example shown in FIG. 3, a primary filter 20 is a fiber filter obtained by laminating two organic fiber layers 12 and 13 to both surfaces of an inorganic fiber layer 11. In such a case, filtration is performed in a manner in which the original coating liquid is poured from the side of the organic fiber layer 12 (the primary side) as shown by the arrow 51, and the primary filtrate is obtained from the side of the organic fiber layer 13, which is arranged on the opposite side of the organic fiber layer 12. In such a case, the shape of the organic fiber layer 12 is stabilized by the inorganic fiber layer 11, and the organic fiber layer 13 arranged on the opposite side of the organic fiber layer 12 is also stabilized by the hard inorganic fiber layer 11, and further, the capability of capturing the foreign matters such as gel is improved owing to the provision of the organic fiber layer 13. Thus, the foreign matters can be more reliably filtered from the coating liquid. Incidentally, the side of the organic fiber layer 13 arranged on the opposite of the organic fiber layer 12 may also be used as the primary side.

### (1-c) Third Example of Primary Filter

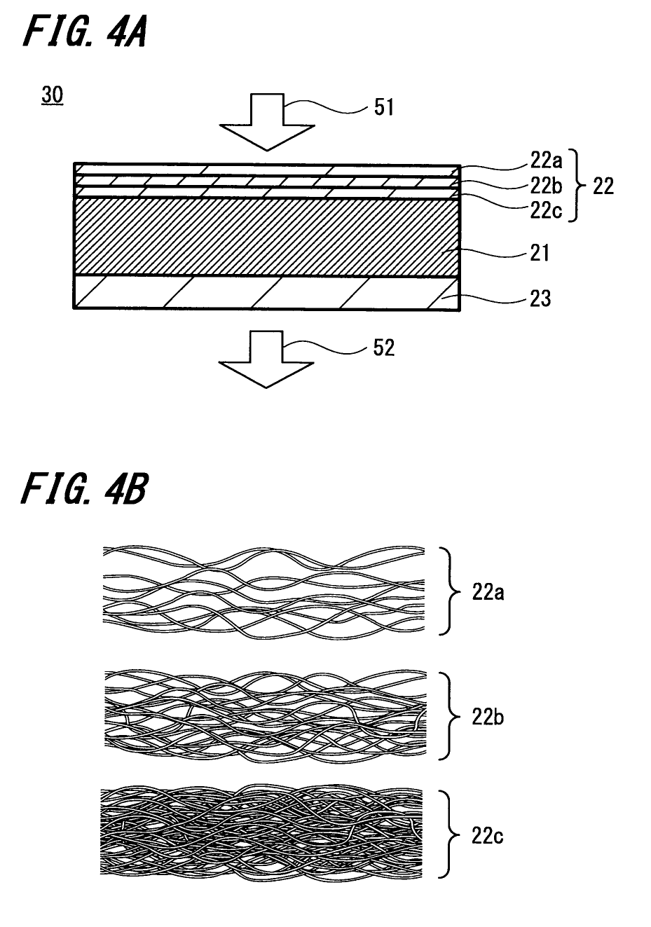

FIG. 4 is a cross section schematically showing the configuration of a third example of the primary filter. In the example shown in FIG. 4A, a primary filter 30 is a fiber filter obtained by arranging an organic fiber layer 22 on one surface of an inorganic fiber layer 21 and arranging an organic fiber layer 23 on the other surface of the inorganic fiber layer 21, wherein the organic fiber layer 22 has a multilayered structure formed by a plurality of layers each having different filtration accuracy, and the organic fiber layer 23 has a single-layer structure. It is preferred that the organic fiber layer 22 having multilayered structure is configured so as to have a filtration accuracy gradient. For example, the organic fiber layer 22 may be configured by laminating an organic fiber layer 22a with relatively low filtration accuracy, an organic fiber layer 22b with intermediate filtration accuracy, and an organic fiber layer 22c with relatively high filtration accuracy in this order from primary side. In such a case, enlarged cross sections of the fiber layers 22a, 22b and 22c are schematically shown in FIG. 4B. With such a configuration, when filtering an original coating liquid containing gel, the gel will be captured in different areas inside the organic fiber layer 22 depending on growth state of the gel, and therefore the primary filter 30 will be less prone to clogging.

Incidentally, although the organic fiber layer 22 having multilayered structure with filtration accuracy gradient is only provided on one surface of the inorganic fiber layer 21 in the example shown in FIGS. 4A and 4B, the same organic fiber layer having multilayered structure may also be provided on the other surface of the inorganic fiber layer 21. Further, the number of the layers of the organic fiber layer having multilayered structure is not limited to three, but may be two, four, or more than four. Furthermore, the inorganic fiber layer 21 may also have a multilayered structure formed by a plurality of layers each having different filtration accuracy. With such a configuration, similar to the example shown in FIG. 4A, since the gel is captured in different areas, clogging of the primary filter as a whole can be restrained.

### (2) Secondary Filter

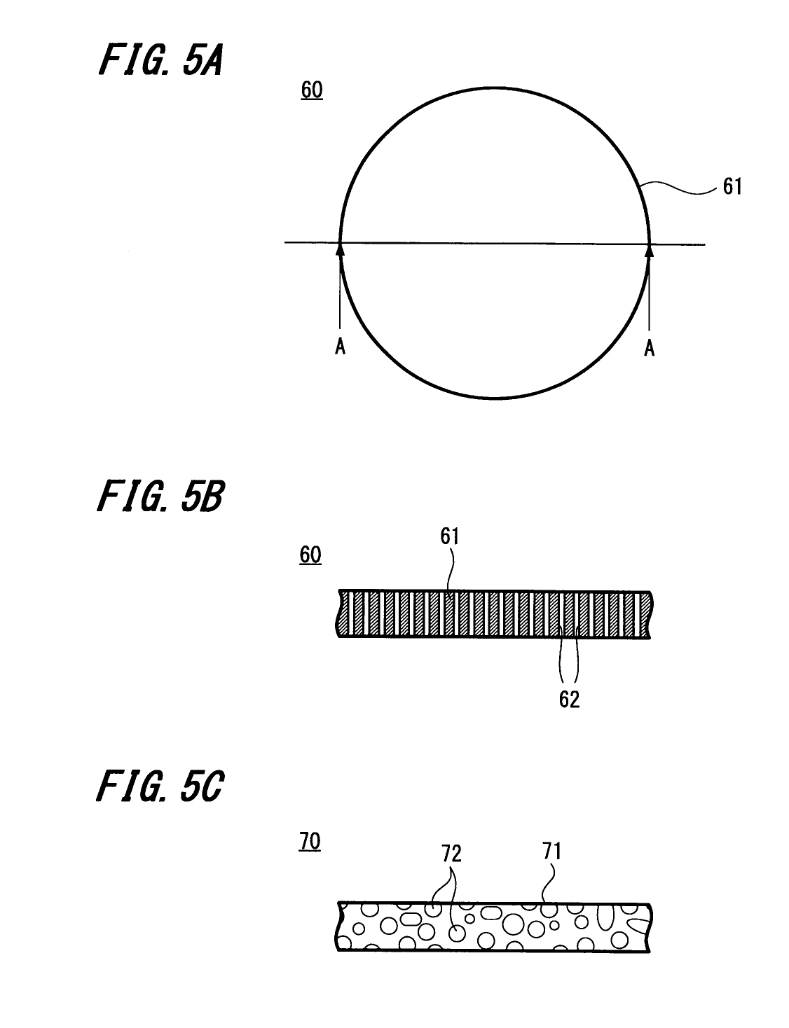

A membrane filter can be preferably used as the secondary filter in the secondary filtration step of the present invention. FIG. 5A is a cross section schematically showing a secondary filter 60 which is a membrane filter, and FIG. 5B is a cross section taken along line A-A of FIG. 5A. In the case where a membrane filter is used as the secondary filter, the configuration thereof is not particularly limited. In the example shown in FIG. 5A, the secondary filter 60 includes a base body 61 made of a cellulose, a resin or the like. The base body 61 has many holes formed therein and has a circular shape in plan view. As shown in FIG. 5B, a plurality of tunnel-like tiny holes 62 extend from the primary side to the secondary side.

Another example of the secondary filter is shown in FIG. 5C in which many bubble-like pores 72, for example, are formed in a base body 71.

It is preferred that the membrane filter as mentioned above is used as the secondary filter, so that, since the pores (or holes) have substantially the same shape, a stable filtration accuracy can be maintained.

### 3. Examples

Next, as examples, coating liquids for spectacle lens were manufactured, and evaluation was performed on the coating liquids.

### (1) Evaluation Method

Evaluation Method for evaluating the primary filter will be described below. First, a plurality of primary filters each having different structure were prepared, and the original coating liquid was filtered with each of the prepared primary filters respectively to obtain the primary filtrate. Next, the primary filtrate was filtered with the secondary filter, and performance of the primary filter was evaluated by measuring the yield value of the obtained filtrate (i.e., the secondary filtration rate). In other words, the more the quantity of the final coating liquid obtained by the secondary filter was, the better the performance of the primary filter was; the less the quantity of the final coating liquid obtained by the secondary filter was, the worse the performance of the primary filter was.

### (2) Original Coating Liquid

An original coating liquid for forming a primer layer in order to improve adhesion between the plastic lens substrate and the functional film was used as the original coating liquid for all examples. The aforesaid original coating liquid was a water-based polyurethane emulsion containing 30-45% by weight polyurethane.

### (3) Primary Filter

In the following examples, a plurality of primary filters each with filtration accuracy of 98% or more, different layer-structure and different diameter of captured particles were used to compare the capability thereof.

### (3-1) Example 1

A capsule-like filter having three layered structure was used as the primary filter. The capsule-like filter had an inorganic fiber layer and two organic fiber layers respectively arranged on both surfaces of the inorganic fiber layer, wherein the inorganic fiber layer was made of glass fiber and the organic fiber layers were made of polyolefin fiber (polypropylene (PP)). As the filtration accuracy, the diameter of captured particles was 1-1.5 μm.

### (3-2) Example 2

A capsule-like filter having three layered structure was used as the primary filter. The capsule-like filter had an inorganic fiber layer and two organic fiber layers respectively arranged on both surfaces of the inorganic fiber layer, wherein the inorganic fiber layer was made of glass fiber and the organic fiber layers were made of polyolefin fiber. As the filtration accuracy, the diameter of captured particles was 0.3 μm.

### (3-3) Example 3

A capsule-like filter was used as the primary filter. The capsule-like filter had an inorganic fiber layer and two organic fiber layers respectively arranged on both surfaces of the inorganic fiber layer, wherein the inorganic fiber layer was made of glass fiber and the organic fiber layers were made of polyolefin fiber with filtration accuracy gradient. Similar to the example shown in FIG. 4B, the organic fiber layer was configured so that the filtration accuracy became gradually higher along the infiltration direction. As the filtration accuracy, the diameter of captured particles was 0.5 μm.

### (3-4) Comparative Example 1

A capsule-like filter obtained by laminating two polypropylene fiber layers to each other was used as the primary filter. As the filtration accuracy, the diameter of captured particles was 1 μm.

### (3-5) Comparative Example 2

A capsule-like filter obtained by laminating three polypropylene fiber layers to each other was used as the primary filter. As the filtration accuracy, the diameter of captured particles was 0.8 μm.

### (3-6) Comparative Example 3

A capsule-like filter mainly configured by a polypropylene fiber layer was used as the primary filter. As the filtration accuracy, the diameter of captured particles was 2 μm.

### (4) Secondary Filter

A membrane filter made of acetylcellulose was used as the secondary filter. The pore size of the membrane filter was 0.8 μm.

### (5) Results

In each of the aforesaid examples, the primary filtrate obtained by performing the primary filtration with the primary filter was poured into the secondary filter to perform the secondary filtration, and the quantity of the secondary filtrate obtained in the secondary filtration was measured to evaluate the performance of the primary filter, wherein the quantity of the primary filtrate for being poured into the secondary filter was set within a range (with an upper limit of 120 ml) which enables the primary filtrate to be filtered when penetrating through the secondary filter. The results are shown in Table 1. Incidentally, in addition to the quantity of the secondary filtrate, the diameter of captured particles (as the filtration accuracy) of the primary filter, the pore size of the secondary filter, and the material and structure of the primary filter are also indicated in Table 1.

TABLE 1

| | Primary | | Material | |
|---|---|---|---|---|
| | Filtration | | (In case of | |
| | Diameter of | Secondary | multilayer filter) | Secondary |
| | Captured | Filtration | Primary Side- | Filtration |
| | Particles | Pore Size | (Intermediate)- | Rate |
| | [μm] | [μm] | Secondary Side | [ml] |
| Example 1 | 1-1.5 | 0.8 | PP-Glass-PP | 70 |
| Example 2 | 0.3 | 0.8 | PP-Glass-PP | 120 or more |
| Example 3 | 0.5 | 0.8 | PP-Glass-PP | 120 or more |
| Comparative | 1 | 0.8 | PP-PP | 30 |
| Example 1 | | | | |
| Comparative | 0.8 | 0.8 | PP-PP-PP | 45 |
| Example 2 | | | | |
| Comparative | 2 | 0.8 | PP | 30 |
| Example 3 | | | | |

As can be known from the above results, in Example 1 to 3 where the primary filter having an inorganic fiber layer made of glass fiber was used, penetration rate of the secondary filter was high, and therefore sufficient yield could be obtained. In contrast, in Comparative Examples 1 to 3 where the primary filter having no inorganic fiber layer made of glass fiber was used, filtration rate of the secondary filter was low.

Further, in Example 1, the diameter of captured particles of the primary filter, as the filtration accuracy of the primary filter, is 1-1.5 μm, which is greater than the diameter of captured particles (0.8 μm) of the secondary filter, as the filtration accuracy of the secondary filter. It is considered from the above results that, in Example 1, since tiny gel was allowed to be penetrated through, the filtration rate of the secondary filter was lower than that of Examples 2 and 3 in which a primary filter having high filtration accuracy and small diameter of captured particles was used.

In Examples 2 and 3, the primary filtrate can penetrate through without clogging. Thus, it can be known that, if the primary filter has a high accuracy, the secondary filter will be unnecessary.

On the other hand, it is deemed that, in the comparative examples, even in Comparative Example 2 in which a filter having diameter of captured particles of 0.8 μm was used, the filtration rate of the secondary filter was low, and foreign matters such as gel larger than 0.8 μm were filtered out by the primary filter.

According to the aforesaid present invention, by performing a primary filtration step with a primary filter having an inorganic fiber layer laminated thereto for stabilizing the fiber shape of the organic fiber layer, and then performing a secondary filtration with a secondary filter, yield of the secondary filtration can be prevented from lowering.

Further, in the case where a filter with high accuracy is used as the primary filter, the secondary filtration can be omitted.

Note that, the present invention is not limited to the aforesaid embodiments and examples, but includes various modifications and variations without departing from the spirit of the present invention.

What is claimed is:

1. A lens manufacturing method comprising:
a substrate forming step for forming a lens substrate;
a coating liquid manufacturing step for manufacturing a coating liquid for being coated on the lens substrate; and
a step for coating the coating liquid on the lens substrate,
wherein the coating liquid manufacturing step includes a filtration step for filtering an original coating liquid with a filter having a fiber structure;
wherein the filter is a fiber filter with a multilayered structure which includes an organic fiber layer formed of organic fiber and an inorganic fiber layer formed of inorganic fiber; and
wherein, in the filtration step, the original coating liquid is filtered with the organic fiber layer side as a primary side.

2. The lens manufacturing method according to claim 1, wherein the filtration step includes a secondary filtration step for filtering a filtrate obtained by the filter with a secondary filter.

3. The lens manufacturing method according to claim 2, wherein the secondary filter is a membrane filter.

4. The lens manufacturing method according to any one of claims 1 to 3, wherein the organic fiber layer is provided on both the primary side and the secondary side of the filter with the inorganic fiber layer interposed therebetween.

5. The lens manufacturing method according to any one of claims 1 to 3, wherein the organic fiber layer is obtained by laminating a plurality of organic fiber layers to each other, each of the organic fiber layers having different filtration accuracy.

6. The lens manufacturing method according to any one of claims 1 to 3, wherein the inorganic fiber is glass fiber.

7. The lens manufacturing method according to any one of claims 1 to 3, wherein the organic fiber is polyolefin fiber.

8. The lens manufacturing method according to any one of claims 1 to 3, wherein the coating liquid is a material containing gel component.

9. The lens manufacturing method according to claim 8, wherein the coating liquid is an emulsified liquid.

10. The lens manufacturing method according to claim 8 or 9, wherein the coating liquid is a water-dispersible polyurethane.

11. The lens manufacturing method according to any one of claims 1 to 3, wherein the coating liquid is a primer liquid for a photochromic film.

12. A coating liquid manufacturing method comprising:
a filtration step for filtering an original coating liquid for lens with a filter having multilayered structure,
wherein the filter having multilayered structure includes an organic fiber layer formed of organic fiber and an inorganic fiber layer formed of inorganic fiber; and
wherein the original coating liquid is filtered with the organic fiber layer side as a primary side.
